(19) United States
(12) Patent Application Publication
(10) Pub. No.: US 2003/0215775 A1
(43) Pub. Date: Nov. 20, 2003

(54) Method of displaying text

(76) Inventor: Paolo Bizziocchi, Viale De Amicis (IT)

Correspondence Address: Thomas M. Champagne, IP Strategies, P.C., Suite 301, 806 7th Street, NW, Washington, DC, 20001, US

(21) Appl. No.: 10/096,746

(22) Filed: Mar. 13, 2002

Related U.S. Application Data
(63) Continuation-in-part of application No. 09/446,392, filed on Apr. 26, 2000, now abandoned.

(51) Int. Cl. G09B 17/00

(52) U.S. Cl. 434/178

(57) ABSTRACT

A method of displaying text such that it is arranged using baselines with curved aspects. As a result, the right end of each text line is formatted visually lower than the corresponding left end of that same text line. The visual effect is that the right end of the text line being read is positioned approximately at the same height as the left end of the subsequent text line. In this manner, as a person's eye shifts focus from the end of the current text line to the beginning of another, it is more likely that the person's eye will focus on the following text line rather than the current one, which the person has already read. The formatting can be implemented by software, such as word processing software.

### FIELD OF THE INVENTION

The present invention relates to formatting for text that facilitates reading and encourages an increase in a reader's speed of reading the text.

### BACKGROUND OF THE INVENTION

Currently, numerous methods exist to increase reading speed without diminishing reading comprehension. However, these methods focus on techniques and strategies that a person undertakes as part of his or her self-improvement. That is, these methods are techniques for training a reader to read differently, and involve the development of new reading skills. Further, books are sometimes published in large text format, or the text is otherwise presented to assist those readers who have poor eyesight. However, the inventor is unaware of any conventional text format that facilitates reading by any person, and helps to increase a person's reading speed without requiring training or special ability on the part of the reader.

It is well recognized that many languages use textual symbols to represent ideas in a written form. In particular, such symbols can have a linear presentation, with multiple lines of symbols arranged to form a column. For example, in English, combinations of symbols, in the form of alphanumeric characters, are used to form words, which are then combined to form sentences. In turn, several sentences can be combined to express the detail and complexity of an idea. For practical reasons, the physical media necessary to record an idea controls the display of longer sentences or groups of sentences. For example, the page of a book has fixed dimensions, which provide for the display of sentences and partial sentences as one or more columns of textual lines. Likewise, the fixed dimensions of a computer display, or even the variable dimensions of a software program window, also provide for the display of sentences and partial sentences as a column of textual lines. As a result, it is necessary for a person to be able to navigate or “read” a column of textual lines before comprehending the ideas represented by that particular set of textual symbols.

In general, a person must know the vocabulary, grammar, syntax, and idioms of a language before being able to read and comprehend the ideas represented by a column of textual lines written in that language. Additionally, there are functional aspects to reading a formatted language that are important to comprehension, but are often overlooked. For example, a person reading a book must be able to distinguish which cover designates the beginning of the book and which designates the end; furthermore, a person must correct the placement of the book so that the textual symbols have a readable orientation. More particularly, a person reading a column of text lines on a page must know how to traverse the textual symbols in order to comprehend the represented ideas. For example, a person reading a customarily-oriented column of textual lines in the English language begins by completely reading the top line in the column, and then sequentially completely reading each line in the column until and including the bottom line in the column is reached. In addition, a person reading the textual symbols contained within each text line begins by reading the textual symbol located at the left end of the text line and then sequentially reading each textual symbol in the text line until and including the textual symbol located at the right end of the same text line. This description of the functional requirements for reading customarily-oriented column of textual lines in the English language shows that a person reading such a column experiences an interruption not only at the end of the bottom line in the column, but also at the end of each text line before beginning to read the next lower text line in the column.

The interruption in reading that a person experiences after reading the textual symbol located at the right end of a line of text, but before reading the textual symbol located at the left end of the next lower line of text in the column, reduces reading speed. This occurs for many reasons. For example, a delay occurs as the eye changes from a left-to-right direction to an approximately right-to-left direction. Further, an additional delay occurs because the focus of the eye must travel the increased distance between the textual symbol located at the right end of a line of text and the textual symbol located at the left end of the next lower line of text. In addition, the focus of the eye has a tendency to travel along an elliptical path while reading. As a result, once the eye ceases to focus on the textual symbol located at the right end of a line of text, it begins to travel along a portion of a shallow elliptical path located between the line of text most recently read and the next lower line of text. This portion of the shallow elliptical path terminates at the textual symbol located at the left end of the line of text most recently read, rather than the left end of the next lower line of text. The eye must then adjust downward to focus on the beginning of the next line of text, consuming additional time. Another consequence of this tendency exhibited by the eye to the person reading is that a line of text that has been read once may be inadvertently read again, which necessarily reduces that person's reading speed. In fact, the tendency of the eye to follow an elliptical path while reading conventionally-formatted text has been shown to reduce reading speed a significant amount, estimated at between 40% and 50%. A text format that compensates for this tendency of the eye to follow an elliptical path while reading and allows a person reading the displayed text to increase reading speed without diminishing reading comprehension would therefore be advantageous.

### SUMMARY OF THE INVENTION

The present invention includes a method of displaying text in a format that compensates for the tendency of the eye to follow an elliptical path while reading, and allows the person reading the displayed text to increase reading speed in a way that does not diminish reading comprehension. The present invention also includes a format for text that facilitates the reading process, and helps to increase reading speed. The displayed text is arranged in a manner that increases the likelihood that a person's eye shifts focus from the end of a current text line to the beginning of a following line of text rather than back to the beginning of the current line of text, which the person has already read. This arrangement reduces the amount of adjustment that must be made by the person's eye motion in picking up the beginning of a next line of text to be read. This also reduces the chance that a line of text is mistakenly read more than once. As a result, an increase in reading speed is facilitated. The method may be implemented by computer software to automatically generate text in this fashion, or to convert conventional text for rapid reading.

The present invention includes a method of displaying text that produces a layout that allows a person reading the displayed text to increase reading speed without diminishing reading comprehension. According to a particular aspect of the present invention, the displayed text is arranged in a standard columnar paragraph format with the text both right and left justified. In addition, all lines have the same spacing and all the characters the same font. The text is then repositioned along new baselines with curved aspects. In a particular embodiment, the upward curve of each text line begins at the centerline of the text column. Additionally, the shape of the curve is established as the arc of a circle having an origin positioned above the text line. While each text line has its own arc origin, all of the arcs within a particular column have the same radius. The result is that the left end of each text line is formatted such that it is visually higher on the page than the corresponding left end of the unformatted text line. In general, the right end of the text line is positioned at about the same height as the left end of the following text line, and the displayed line approximates the elliptical path naturally followed by the eyes when reading. Thus, the eyes must make fewer adjustments when transitioning from the end of one line of text to the beginning of the next line of text. In this manner, as a person's eye shifts focus from the end of the current text line to the beginning of another, it is more likely that the person's eye will focus on the following text line rather than the current one, which the person has already read. The foregoing effects result in a likelihood of an increase in reading speed.

According to a particular aspect of the present invention, a formatted text display includes a column of text lines. The text lines have a plurality of characters, including a leading character that is intended to be read first, a trailing character that is intended to be read last, and a plurality of intervening characters disposed between the leading character and the trailing character. The leading character of at least one of said text lines is disposed at an elevation with respect to the display that is higher than an elevation at which the trailing character of said at least one of said text lines is disposed. A contiguous grouping of the intervening characters of said at least one of said text lines is arranged such that a first character in the contiguous grouping of the intervening characters is disposed closest to the leading character, among the characters in the continuous grouping, and is disposed at an elevation that is lower than the elevation at which the leading character is disposed. Further, each successive character of said contiguous grouping of the intervening characters, after the first character, is disposed at an elevation that is lower than the elevation at which the character preceding the respective successive character is disposed. In addition, a last character in the contiguous grouping of the intervening characters is disposed closest to the trailing character, among the characters in the continuous grouping, and is disposed at an elevation that is higher than the elevation at which the trailing character is disposed. The elevations of the contiguous grouping of the intervening characters of said at least one of said text lines can follow an arc of a curve. The curve can be a circle. The elevation at which the leading character is disposed can be substantially the same as an elevation of a trailing character of a preceding text line of the column of text lines. The last character in the contiguous grouping of the intervening characters can be disposed substantially at a mid-point of said at least one of said text lines. All characters of said at least one of said text lines can have the same font.

According to another aspect of the present invention, a method of displaying formatted text includes establishing a column of text lines having a plurality of characters, including a leading character that is intended to be read first, a trailing character that is intended to be read last, and a plurality of intervening characters disposed between the leading character and the trailing character. The leading character of at least one of said text lines is arranged at an elevation with respect to the display that is higher than an elevation at which the trailing character of said at least one of said text lines is disposed. A contiguous grouping of the intervening characters of said at least one of said text lines is arranged such that a first character in the contiguous grouping of the intervening characters is disposed closest to the leading character, among the characters in the continuous grouping, and is disposed at an elevation that is lower than the elevation at which the leading character is disposed. Each successive character of said contiguous grouping of the intervening characters, after the first character, is disposed at an elevation that is lower than the elevation at which the character preceding the respective successive character is disposed. A last character in the contiguous grouping of the intervening characters is disposed closest to the trailing character, among the characters in the continuous grouping, and is disposed at an elevation that is higher than the elevation at which the trailing character is disposed. The elevations of the contiguous grouping of the intervening characters of said at least one of said text lines can be arranged to follow an arc of a curve. The curve can be a circle. The elevation at which the leading character is disposed can be arranged to be substantially the same as an elevation of a trailing character of a preceding text line of the column of text lines. The last character in the contiguous grouping of the intervening characters can be arranged to be disposed substantially at a mid-point of said at least one of said text lines. All characters of said at least one of said text lines can have the same font.

According to another aspect of the present invention, a storage medium includes instructions for causing a data processor to display formatted text. The instructions include establish a column of text lines having a plurality of characters, including a leading character that is intended to be read first, a trailing character that is intended to be read last, and a plurality of intervening characters disposed between the leading character and the trailing character; arrange the leading character of at least one of said text lines at an elevation with respect to the display that is higher than an elevation at which the trailing character of said at least one of said text lines is disposed; and arrange a contiguous grouping of the intervening characters of said at least one of said text lines such that a first character in the contiguous grouping of the intervening characters is disposed closest to the leading character, among the characters in the continuous grouping, and is disposed at an elevation that is lower than the elevation at which the leading character is disposed, each successive character of said contiguous grouping of the intervening characters, after the first character, is disposed at an elevation that is lower than the elevation at which the character preceding the respective successive character is disposed, and a last character in the contiguous grouping of the intervening characters is disposed closest to the trailing character, among the characters in the continuous grouping, and is disposed at an elevation that is higher than the elevation at which the trailing character is disposed. The instructions can also include arrange the elevations of the contiguous grouping of the intervening characters of said at least one of said text lines to follow an arc of a curve. The curve can be a circle. The instructions can also include arrange the elevation at which the leading character is disposed to be substantially the same as an elevation of a trailing character of a preceding text line of the column of text lines. The instructions can also include arrange the last character in the contiguous grouping of the intervening characters to be disposed substantially at a mid-point of said at least one of said text lines. All characters of said at least one of said text lines can have the same font.

### BRIEF DESCRIPTION OF THE DRAWINGS

FIG. 1 shows exemplary ordinary text in a columnar format having uniform line spacing and right and left justification.

FIG. 2 shows geometric references for the same text shown in FIG. 1.

FIG. 3 shows a single text line with geometric references.

FIG. 4 shows exemplary text modified according to the present invention.

FIG. 5 shows a single uncurved text line with geometric references.

FIG. 6 shows a curved version of the same text line shown in FIG. 5.

FIG. 7 shows the geometry of phantom lines used in an exemplary embodiment of the present invention.

FIG. 8 shows a column of text, all of which is displayed according to the format of the present invention.

FIG. 9A shows a column of text displayed according to the present invention.

FIG. 9B shows a column of the text shown in FIG. 9A, displayed conventionally.

### DETAILED DESCRIPTION OF THE INVENTION

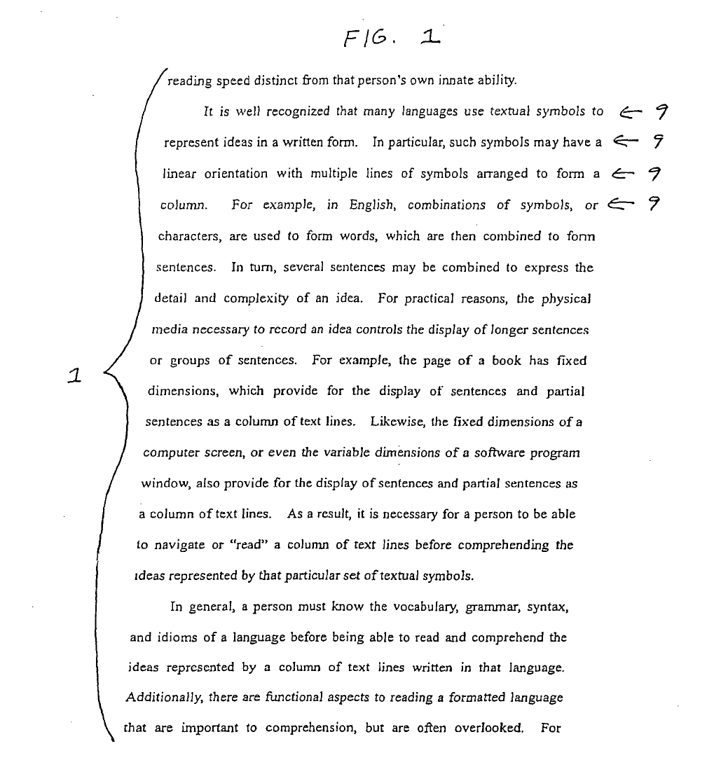

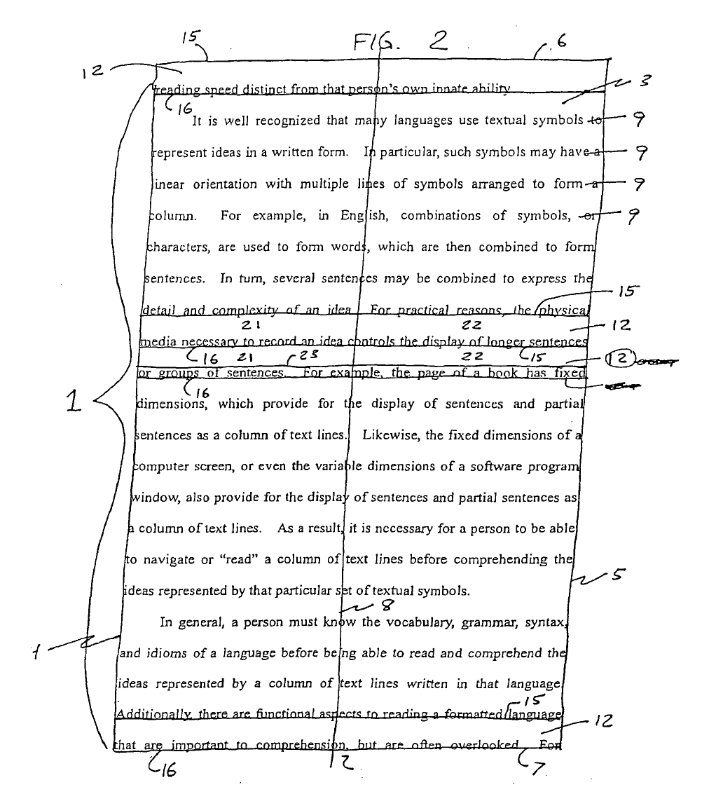

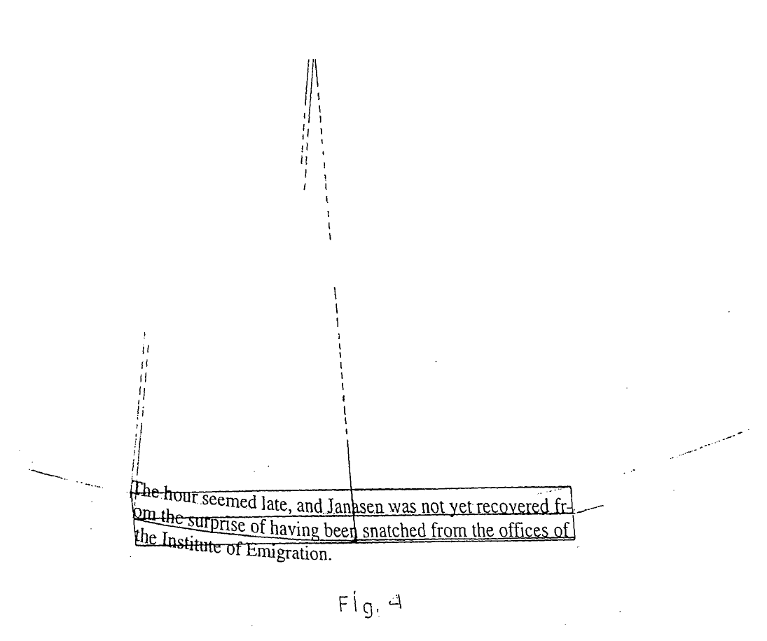

A method of displaying text to increase reading speed is illustratively described by referring to ordinary text 1, which is a column of text lines 9 as shown in FIG. 1, and demonstrating modifications made to the ordinary text I in order to produce transformed text 2 as shown in FIG. 4. FIG. 2 shows the ordinary text 1 as shown in FIG. 1, with reference lines to note certain geometry, which is referenced in order to illustrate the method of displaying the transformed text 2. It is important to note that while this geometry is shown in FIG. 2 for illustration, it is not to be included as part of the display of the transformed text 2. That is, the geometry added to the text is imaginary, and is presented herein as “phantom” structures used as guides for modifying the text and for ease in describing the format of the modified text. As part of the geometry, the ordinary text I is disposed within the rectangular-shaped column region 3, which is bounded by a column left justification line 4, a column right justification line 5, a column headline 6, and a column baseline 7. The column left justification line 4 is vertical and forms the left-most bound of the column of ordinary text 1. That is, the textual symbol located at the left end of each text line 9 is disposed to the right of, and does not cross, the column left justification line 4, although in some embodiments the left-most text can touch the column left justification line 4. Some lines of text, such as text lines 9 that are indented, are disposed well to the right of the column left justification line 4.

Likewise, the column right justification line 5 is vertical and forms the right-most bound of the column of ordinary text 1. That is, the textual symbol located at the right end of each text line 9 is disposed to the left of, and does not cross, the column right justification line 5, although in some embodiments the right-most text can touch the column right justification line 5. If the column of ordinary text 1 is left- and right-justified, that is, arranged such that the text is aligned at the left and right margins as shown in the exemplary embodiment of FIG. 2, the text immediately to the left of the column right justification line 5 is disposed proximate to, or touching, the column right justification line 5. If the text is only left justified, as is common in printed matter, the column right justification line 5 defines the right-most bound of all the text in that column. Thus, the left-most text of the longest line in the column is disposed proximate to, or touching, the column right justification line 5, and the rest of the text is disposed to the left of the column right justification line 5.

A centerline 8 is disposed parallel to the column left justification line 4 and the column right justification line 5. Also, in the exemplary embodiment shown in FIG. 2, the distance between the column left justification line 4 and the centerline 8 is substantially equal to the distance between the centerline 8 and the column right justification line 5. A column headline 6 is a horizontal line disposed at the top of the column, and serves as the upper boundary for the column region 3. Similarly, a column baseline 7 is a horizontal line disposed at the bottom of the column and serves as the lower boundary for the column region 3.

Each text line 9 is disposed within a rectangular-shaped text region 12, which is bounded and defined by the column left justification line 4, the column right justification line 5, a text region headline 15, and a text region baseline 16. Many of the geometric references shown in FIG. 2 have the same location. For example, the column headline 6 coincides with the text region headline 15 for the text region 12 located at the top of the column region 3, that is, the text region headline 15 for the text region 12 of the top line of text in the column. Likewise, the column baseline 7 has coincides with the text region baseline 16 for text region 12 located at the bottom of column region 3, that is, the text region baseline 16 for the text region 12 of the bottom line of text in the column. Generally, other than the text region baseline 16 for the text region 12 located at the bottom of the column region 3, the text region baseline 16 for one text region 12 has the same location as the text region headline 15 for the next lower adjacent text region 12. Similarly, other than the text region headline 15 for the text region 12 located at the top of the column region 3, the text region headline 15 for one text region 12 has the same location as the text region baseline 16 for the next higher adjacent text region 12.

Thus, according to the exemplary embodiment, each text region 12 is divided substantially equally by the centerline 8 into a left text area 21 and a right text area 22. In the exemplary embodiment, the text region baseline 16 is disposed so as to touch the bottoms of the upper case letters of a type font; alternatively, the text region baseline 16 can be spaced from the bottoms of the upper case letters, or from the bottoms of all the letters. In the embodiment shown, the text region baseline 16 is disposed so as to touch the bottoms of the lower case letters as well, except that certain letters, such as ‘p’ and ‘y’, have descenders that extend below text region baseline 16. The text region baseline 16 can disposed so as to connect the bottoms of the descenders instead, or to be spaced from the bottoms of all the letters.

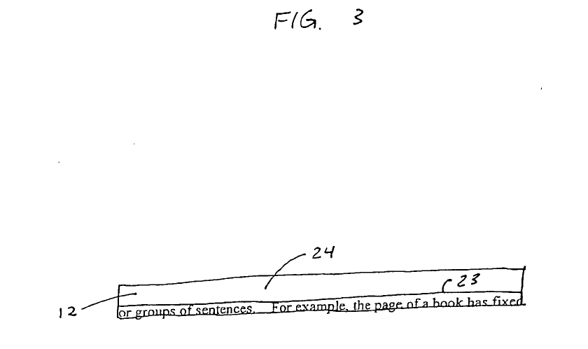

In addition, each text region 12 has a highline 23, which represents the highest elevation reached by a character within a particular text region 12. For example, the highline 23 shown in FIG. 3 illustrates that the top of the 14-point Times Roman upper case ‘F’ represents the highest elevation reached by the top of any character in that particular text region 12. In this instance, the top of the upper case ‘F ’ designates the location of highline 23 for the text region 12 shown. A text gap 24 is the area disposed within the text region 12 above the highline 23. Each text region 12 can have a highline 23 with its own respective elevation, but preferably, within a column of text lines 9, the elevation of the highline 23 is the same for each text line region 12. Thus, in a preferred embodiment, the highline 23 for each text region 12 in a column will be defined by the upper case letter in that column having the highest elevation.

The method of displaying text to facilitate reading according to the present invention requires modifications to ordinary text I such as that shown in FIGS. 1 and 2. In order to display the text according to the invention, a column region 3 of text line regions 12 is defined that have a uniform size and share a column left justification line 4 and share a column right justification line 5 in which text lines 9 are disposed within corresponding text line regions 12. In the embodiment shown, other than indented or truncated text, each text line 9 is both right and left justified within a corresponding text line region 12. In the general case, all the text is bounded by a column left justification line 4 and a column right justification line 5, whether or not the text is justified within these bounds. In addition, highlines 23 are defined for each text line region 12, either separately or to conform to a universal highline height for the column. This is most easily accomplished if all the text in the column is displayed in the same font, but this restriction is not necessary. Adopting a universal highline height results in text gap areas 24 that have a uniform size throughout the column region 3, so such an exemplary embodiment is described herein for ease of explanation.

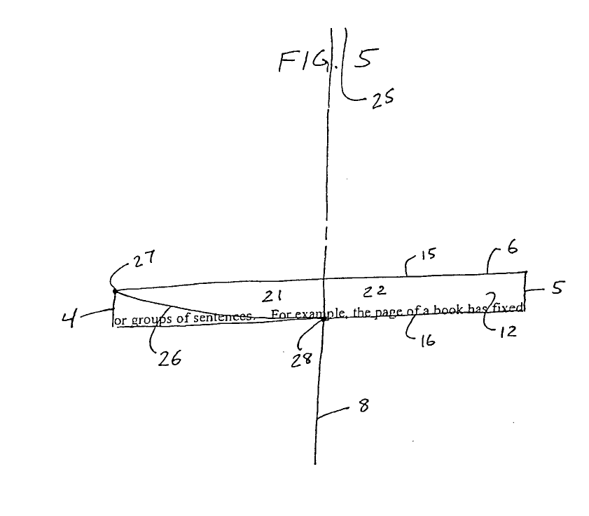

A point identified as the text line region arc origin 25 shown in FIG. 5 is then identified, which serves as the origin of a circle having a text line region arc 26 that traverses a left text line area 21 of the text line region 12 from a left arc endpoint 27 to a right arc endpoint 28. The diameter of the circle incorporating the text line region arc 26 must be large enough to allow the text line region arc 26 to intersect both the left arc endpoint 27 and the right arc endpoint 28. The left arc endpoint 27 is located at the intersection of the column left justification line 4 and the text region headline 15 for a particular text region 12. The corresponding right arc endpoint 28 is located at the intersection of the centerline 8 and the text region baseline 16 for that same text region 12. The text line region arc origin 25 for the text region 12 located at the top of the column region 3 is disposed above the column headline 6 and intersects the centerline 8. The exact location on the centerline 8 where the text line region arc origin 25 is located depends on the geometry of the unmodified text 1. That is, the length of the line from the column left justification line 4 and the column right justification line 5, as well as the overall height of the text line region 12, will determine the path and degree of curvature of the text line region arc 26, and therefore the distance from the right arc endpoint 28 to the text line region arc origin 25.

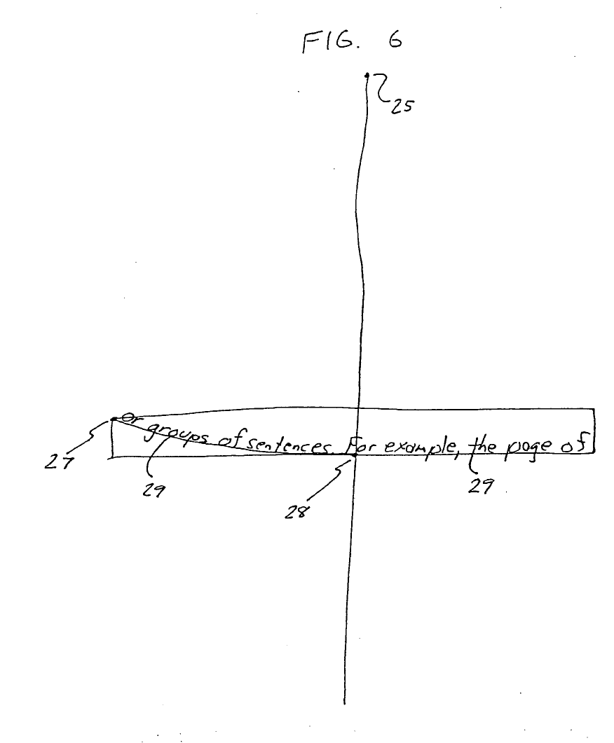

The text line region arc 26 for the text region 12 located at the top of the column region 3, which traverses the left text line area 21 of the text line region 12 from the left arc endpoint 27 to the right arc endpoint 28, can now be defined. Once established, the text line region arc 26 serves as the curved portion of the modified baseline 29 as shown in FIG. 6. In this manner, within the area of a particular text line region 12, the modified baseline 29 includes the text line region arc 26, the portion of the text line region baseline 16 contained within the right text area 22, and the corresponding intersection identified by the right arc endpoint 28.

In the exemplary embodiment shown, the modified baseline 29 has the same function as the text region baseline 16 in that it serves as the boundary for the bottoms of the upper case letters of the text. Also, as with the text region baseline 16, the lower case letters appear to rest on the modified baseline 29 as well, with the same exception that certain letters such as ‘p’ and ‘y’ have descenders that extend below modified baseline 29. In the general case, the modified baseline 29 will serve as some bound for the text in the text line region 12, preferably, but not necessarily, corresponding to that previously provided by the text region baseline 16 for the unmodified text.

The same modification is substantially repeated for each text line region 12 in the column region 3. Each text line region 12 has a corresponding text line region arc origin 25 with a different location along the centerline 8. The distance between left arc endpoints 27 for two modified baselines 29 within a column region 3 is the same as the distance between corresponding text line region arc origins 25 and right arc endpoints 28, namely, the height of a text line region 12.

Once the modified baselines 29 are established, the text characters contained within each left text area 21 are repositioned to follow the text line region arc 26. For example, this repositioning can be implemented by having the text curve in orientation to adapt to the curve of the text line region arc 26. Alternatively, the text can retain the original rotational orientation, but can be displaced vertically so as to follow the curve of the text line region arc 26. As viewed from centerline 8 moving in the direction toward column left justification line 4, the relative positions of each character within a text line 9 do not change. Because the length of the text line region arc 26 is longer than the portion of the text region baseline 16 contained within left text area 21, the leftmost character of a text line 9 need not extend and intersect the left arc endpoint 27. However, the leftmost characters of the repositioned text line 9 intersect and cross the text region headline 15. In this manner, portions of the leftmost characters positioned on the modified baseline 29 extend into the adjacent higher text line region 12. The result is that the text region baseline 16 now intersects characters from two adjacent text lines 9. Thus, as shown in FIG. 4, text from a subsequent line actually begins on the left end of the text region baseline 16 of the line of text preceding it. Thus, as the eye travels from the end of a line of text to the left side of the column, the eye will pick up the beginning of the next line of text on the same baseline as that of the end of the previous line of text. The natural motion of the eyes as a person is reading will therefore pick up the next line of text more easily, and reading speed can be increased without training effort.

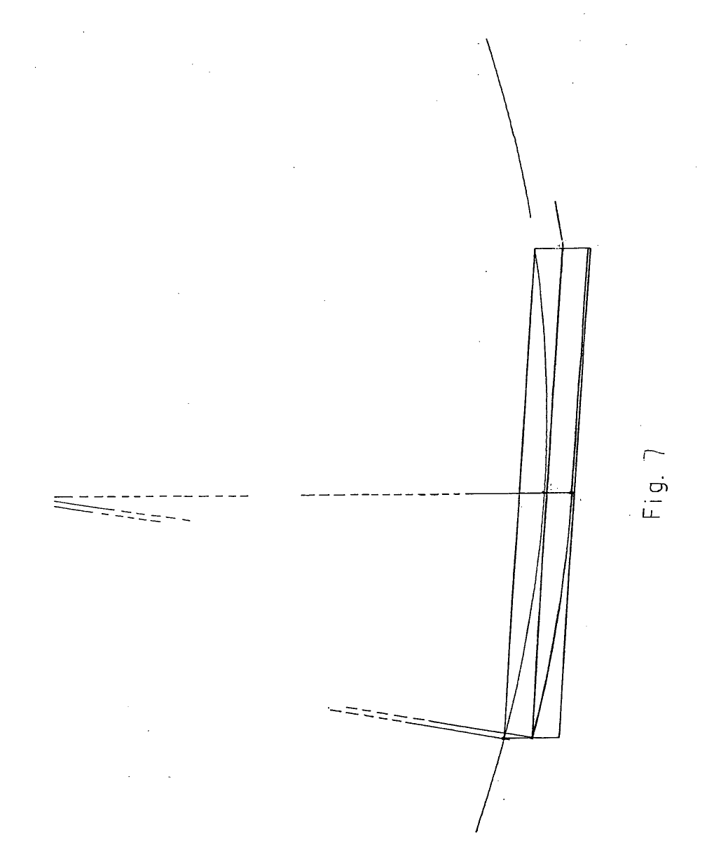

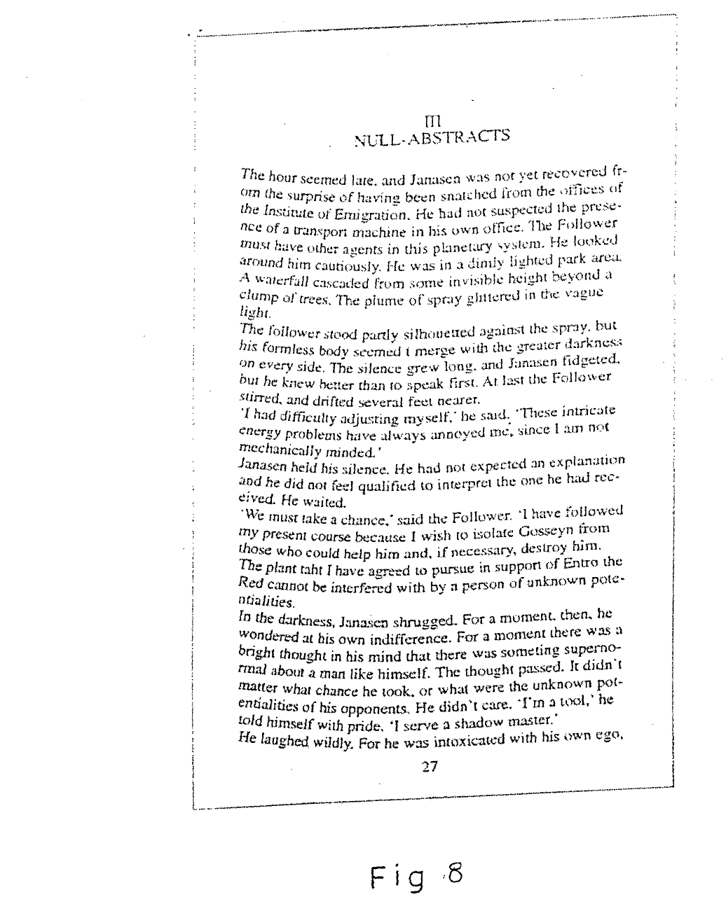

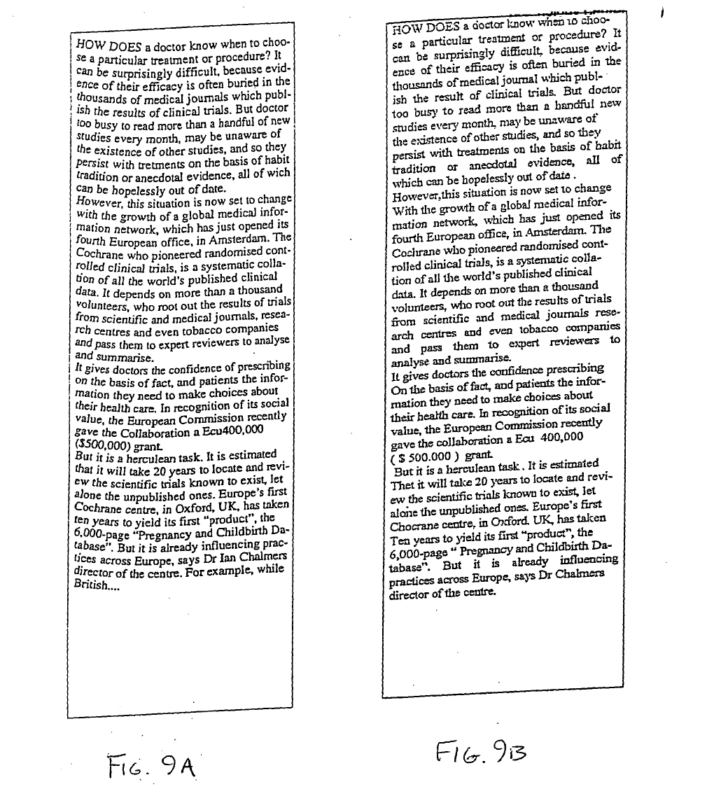

To further promote understanding of the present invention, FIG. 7 shows the geometry of the phantom lines used in the exemplary embodiment described above, without inclusion of any text characters. FIG. 8 shows a column of text, all of which is displayed according to the format of the present invention. Note that the heading is presented in a conventional format. FIG. 9 shows two columns of text. FIG. 9A shows a column of text displayed according to the present invention. For contrast, FIG. 9B shows a column of the same text, displayed conventionally.

The exemplary embodiment described above results in a modification of the text on the left side of the column. This modification is suited for text that is meant to be read in a left-to-right direction. A similar modification can be made to the text on the right side of the column instead, in order to provide a similar benefit for readers of text that is meant to be read in a right-to-left direction.

The process for modifying text according to the present invention can be implemented in software, which can automatically calculate the curvature of the modified baseline and the placement of the text according to the values of parameters for the subject text. Thus, the software can be included in word processing programs, which can display text that is formatted according to the principles of the while the text is displayed to a user as it is keyed by the user. Alternatively, the text can be entered by the user and displayed conventionally, until the format of the text modification is selected as an option. As another alternative, the text modification can be selected as an option for printing only. As known to those of skill in the art, modern printers, such as laser printers, can easily print text in any of a variety of formats, and can be adapted to print according to the format described herein. Other publishing and printing platforms can be adapted to modify the format of displayed and printed according to the present invention. Accordingly, any storage medium, such as various magnetic or optical media, storing or including instructions that cause a data processor to format text according to the present invention for any purpose, are articles of manufacture that are considered to fall within the scope of the present invention.

Particular exemplary embodiments of the present invention have been described in detail. These exemplary embodiments are illustrative of the inventive concept recited in the appended claims, and are not limiting of the scope or spirit of the present invention as contemplated by the inventors. For example, the formatting can be taken further and applied to both right and left sides of a column of text. The centerline can be skewed, so that it is not truly a center line but rather an offset radius of the modified baseline. If both sides of the column are modified, the resulting baseline will have one end that is higher than the other. Further, the modified baseline need not be an arc of a circle, and some other basis for the curvature can be devised instead, or the modified baseline can be represented as a ramp. Other parameters, such as the location of the left arc endpoint, the size of the text gap, and the relative position of the text with respect to the baseline, for example, can be varied to provide modified text according to the present invention.

What is claimed is:

1. A formatted text display comprising a column of text lines, wherein:
the text lines have a plurality of characters, including a leading character that is intended to be read first, a trailing character that is intended to be read last, and a plurality of intervening characters disposed between the leading character and the trailing character;
the leading character of at least one of said text lines is disposed at an elevation with respect to the display that is higher than an elevation at which the trailing character of said at least one of said text lines is disposed; and
a contiguous grouping of the intervening characters of said at least one of said text lines is arranged such that
a first character in the contiguous grouping of the intervening characters is disposed closest to the leading character, among the characters in the continuous grouping, and is disposed at an elevation that is lower than the elevation at which the leading character is disposed,
each successive character of said contiguous grouping of the intervening characters, after the first character, is disposed at an elevation that is lower than the elevation at which the character preceding the respective successive character is disposed, and
a last character in the contiguous grouping of the intervening characters is disposed closest to the trailing character, among the characters in the continuous grouping, and is disposed at an elevation that is higher than the elevation at which the trailing character is disposed.

2. The formatted text display of claim 1, wherein the elevations of the contiguous grouping of the intervening characters of said at least one of said text lines follows an arc of a curve.

3. The formatted text display of claim 2, wherein the curve is a circle.

4. The formatted text display of claim 1, wherein the elevation at which the leading character is disposed is substantially the same as an elevation of a trailing character of a preceding text line of the column of text lines.

5. The formatted text display of claim 1, wherein the last character in the contiguous grouping of the intervening characters is disposed substantially at a mid-point of said at least one of said text lines.

6. The formatted text display of claim 1, wherein all characters of said at least one of said text lines have the same font.

7. A method of displaying formatted text, comprising:
establishing a column of text lines having a plurality of characters, including a leading character that is intended to be read first, a trailing character that is intended to be read last, and a plurality of intervening characters disposed between the leading character and the trailing character;
arranging the leading character of at least one of said text lines at an elevation with respect to the display that is higher than an elevation at which the trailing character of said at least one of said text lines is disposed; and
arranging a contiguous grouping of the intervening characters of said at least one of said text lines such that
a first character in the contiguous grouping of the intervening characters is disposed closest to the leading character, among the characters in the continuous grouping, and is disposed at an elevation that is lower than the elevation at which the leading character is disposed,
each successive character of said contiguous grouping of the intervening characters, after the first character, is disposed at an elevation that is lower than the elevation at which the character preceding the respective successive character is disposed, and
a last character in the contiguous grouping of the intervening characters is disposed closest to the trailing character, among the characters in the continuous grouping, and is disposed at an elevation that is higher than the elevation at which the trailing character is disposed.

8. The method of claim 7, further comprising arranging the elevations of the contiguous grouping of the intervening characters of said at least one of said text lines to follow an arc of a curve.

9. The method of claim 8, wherein the curve is a circle.

10. The method of claim 7, further comprising arranging the elevation at which the leading character is disposed to be substantially the same as an elevation of a trailing character of a preceding text line of the column of text lines.

11. The method of claim 7, further comprising arranging the last character in the contiguous grouping of the intervening characters to be disposed substantially at a mid-point of said at least one of said text lines.

12. The method of claim 7, wherein all characters of said at least one of said text lines have the same font.

13. A storage medium including instructions for causing a data processor to display formatted text, wherein the instructions comprise:
establish a column of text lines having a plurality of characters, including a leading character that is intended to be read first, a trailing character that is intended to be read last, and a plurality of intervening characters disposed between the leading character and the trailing character;
arrange the leading character of at least one of said text lines at an elevation with respect to the display that is higher than an elevation at which the trailing character of said at least one of said text lines is disposed; and
arrange a contiguous grouping of the intervening characters of said at least one of said text lines such that
a first character in the contiguous grouping of the intervening characters is disposed closest to the leading character, among the characters in the continuous grouping, and is disposed at an elevation that is lower than the elevation at which the leading character is disposed,
each successive character of said contiguous grouping of the intervening characters, after the first character, is disposed at an elevation that is lower than the elevation at which the character preceding the respective successive character is disposed, and
a last character in the contiguous grouping of the intervening characters is disposed closest to the trailing character, among the characters in the continuous grouping, and is disposed at an elevation that is higher than the elevation at which the trailing character is disposed.

14. The storage medium of claim 13, wherein the instructions further comprise arrange the elevations of the contiguous grouping of the intervening characters of said at least one of said text lines to follow an arc of a curve.

15. The storage medium of claim 14, wherein the curve is a circle.

16. The storage medium of claim 13, wherein the instructions further comprise arrange the elevation at which the leading character is disposed to be substantially the same as an elevation of a trailing character of a preceding text line of the column of text lines.

17. The storage medium of claim 13, wherein the instructions further comprise arrange the last character in the contiguous grouping of the intervening characters to be disposed substantially at a mid-point of said at least one of said text lines.

18. The storage medium of claim 13, wherein all characters of said at least one of said text lines have the same font.
